(19) United States
(12) Patent Application Publication
(10) Pub. No.: US 2019/0286299 A1
(43) Pub. Date: Sep. 19, 2019

(54) METHOD FOR UNLOCKING AN ELECTRONIC DEVICE

(71) Applicant: I SHOU UNIVERSITY, Kaohsiung City (TW)

(72) Inventor: Shyh-Chang Liu, Kaohsiung City (TW)

(21) Appl. No.: 16/100,674

(22) Filed: Aug. 10, 2018

(30) Foreign Application Priority Data
Mar. 16, 2018 (TW) 107108965

(51) Int. Cl. G06F 3/0484; G06F 3/041; G06F 3/0488; G06F 21/36

(52) U.S. Cl. CPC G06F 3/04842; G06F 21/36; G06F 3/04883; G06F 3/0416

(57) ABSTRACT

A method for unlocking an electronic device including a touchscreen is provided. The method includes steps of: displaying, on the touchscreen, a plurality of objects including at least one first object and at least one second object that is related to the first object; detecting contact with the touchscreen at a first location corresponding to the first object; continuously moving the first object on the touchscreen in accordance with movement of the contact while the contact with the touchscreen is continuously maintained; and unlocking the electronic device when the first object is moved to a second location that corresponds to the second object.

### CROSS-REFERENCE TO RELATED APPLICATION

This application claims priority to Taiwanese Patent Application No. 107108965 filed on Mar. 16, 2018.

### FIELD

The disclosure relates to a method for operating an electronic device, more particularly to a method for unlocking an electronic device.

### BACKGROUND

When an electronic device is locked (e.g., via lock screen technology), access thereto is disabled and an unlocking process must be performed in order to gain access to the electronic device.

Referring to FIGS. 1 and 2, in a conventional unlocking method for an electronic device disclosed in Taiwanese Invention Patent No. 1470539, a plurality of objects 11 such as triangles, rectangles and parallelograms are displayed by the electronic device, and a user of the electronic device may compose a predetermined specific pattern 100 using one or more of the objects 11 so as to unlock the electronic device. However, such objects 11 are merely geometric figures with no specific meaning.

### SUMMARY

Therefore, an object of the present disclosure is to provide an alternative method for unlocking an electronic device.

According to one aspect of the present disclosure, the method for unlocking an electronic device including a touchscreen is provided. The method includes steps of:

displaying, on the touchscreen, a plurality of objects including at least one first object and at least one second object that is related to the first object;

detecting contact with the touchscreen at a first location corresponding to the first object;

continuously moving the first object on the touchscreen in accordance with movement of the contact while the contact with the touchscreen is continuously maintained; and

unlocking the electronic device when the first object is moved to a second location that corresponds to the second object.

### BRIEF DESCRIPTION OF THE DRAWINGS

Other features and advantages of the present disclosure will become apparent in the following detailed description of the embodiments with reference to the accompanying drawings, of which:

FIGS. 1 and 2 are schematic diagrams illustrating a conventional unlocking method for an electronic device disclosed in Taiwanese Invention Patent No. 1470539;

FIG. 3 is a flow chart illustrating a method for unlocking an electronic device according to one embodiment of the present disclosure;

FIGS. 4 to 6 are schematic diagrams of different examples of the electronic device implementing the method of FIG. 3 according to one embodiment of the present disclosure;

FIG. 7 is a block diagram of an electronic device for implementing the method of FIG. 3 according to some embodiments of the present disclosure;

FIGS. 8 and 9 are schematic diagrams of the electronic device implementing the method of FIG. 3 according to another embodiment of the present disclosure; and

FIG. 10 is a schematic diagram of different examples of the electronic device implementing the method of FIG. 3 according to another embodiment of the present disclosure.

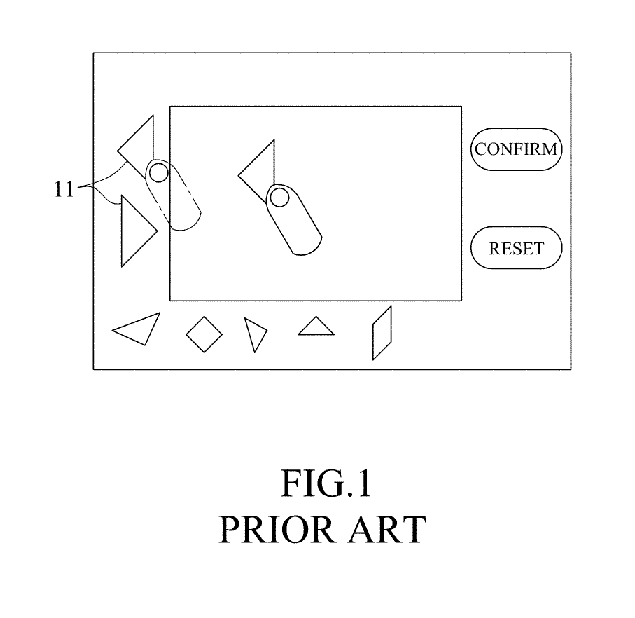

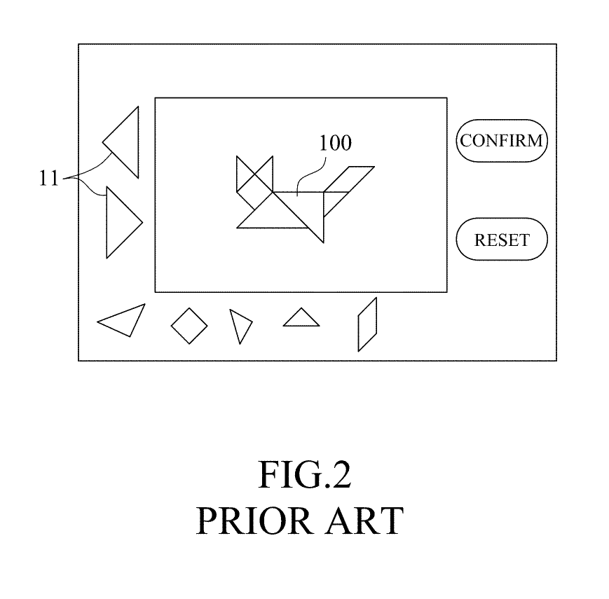

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

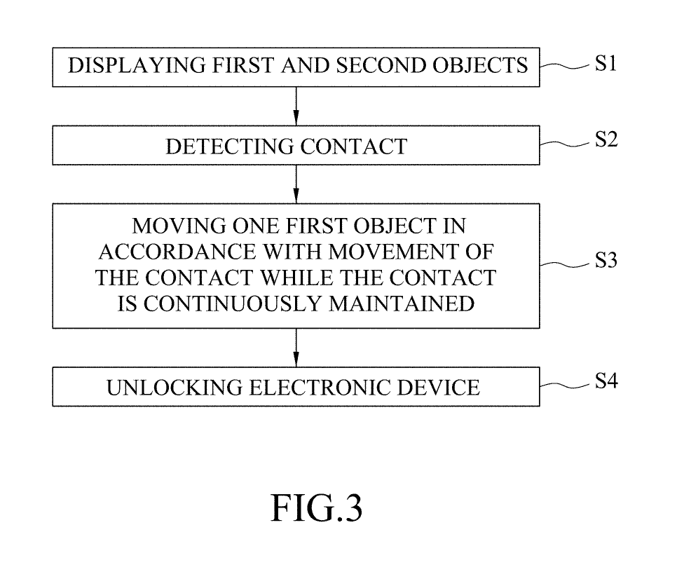

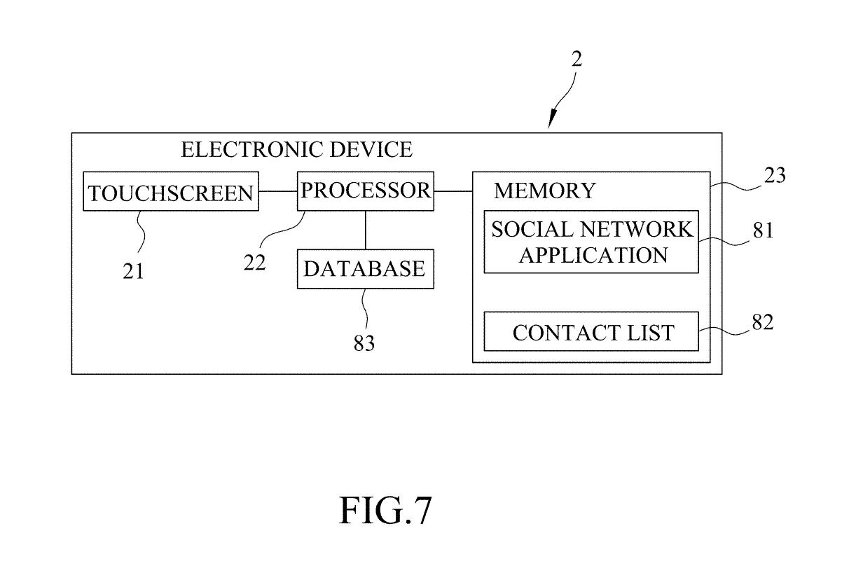

Referring to FIG. 3, a method for unlocking an electronic device according to one embodiment of the present disclosure is shown. Further referring to FIG. 7, the electronic device 2 is, for example, a mobile device, and includes a touchscreen 21 and a processor 22 electrically connected to the touchscreen 21 and for performing the method for unlocking a mobile electronic device 2. The method includes the following steps.

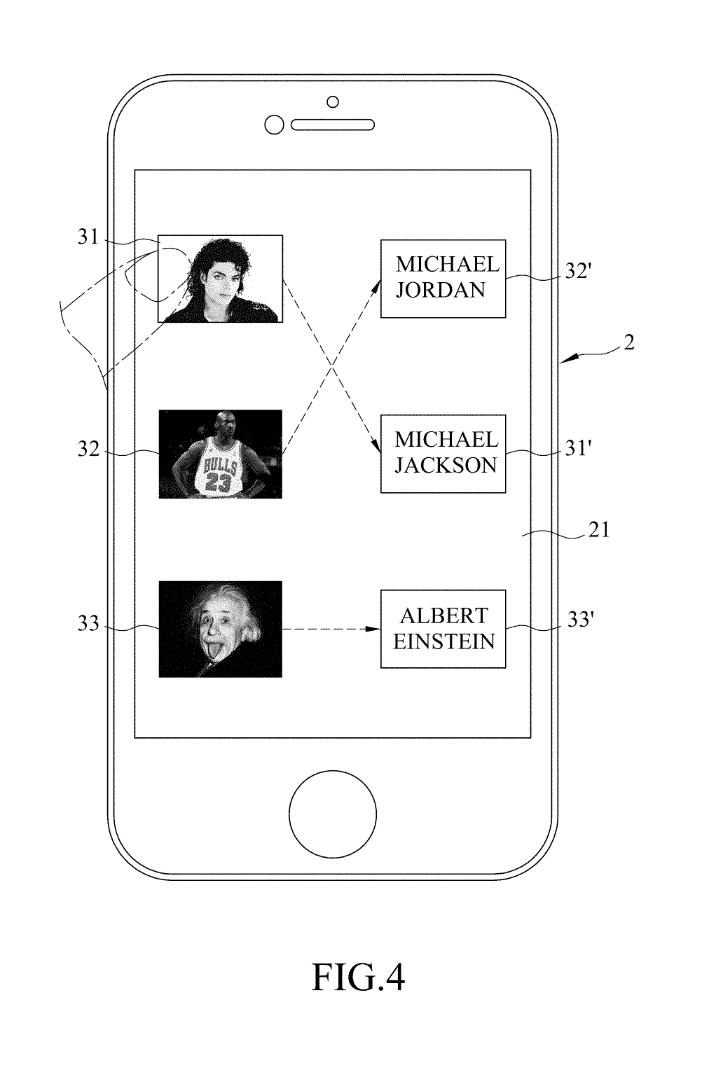

In step S1, the touchscreen 21 displays a plurality of objects including at least one first object and at least one second object that is related to the first object. In some embodiments, the plurality of objects include three or more first objects (e.g., three first objects in FIG. 4, to the left) and three or more second objects (e.g., three second objects in FIG. 4, to the right). The second objects correspond to the first objects in number, are respectively related to the first objects, and have a logical relationship with the first objects, respectively. The logical relationship herein may involve mathematical logic, logical reasoning, or generally accepted association of things, etc.

In step S2, the electronic device 2 detects contact with the touchscreen 21 at a first location corresponding to the at least one first object. In step S3, the electronic device 2 continuously moves the at least one first object displayed on the touchscreen 21 in accordance with movement of the contact while the contact with the touchscreen 21 is continuously maintained. In some embodiments, having multiple first objects and corresponding second objects displayed in step S1, steps S2 and S3 should be repeated to move all of the first objects.

In step S4, upon the at least one first object being moved to a second location that corresponds to the at least one second object related to the at least one first object, the electronic device 2 is unlocked. In some embodiments having multiple first objects and corresponding second objects displayed in step S1, the electronic device 2 is unlocked only when each of the first objects is moved to a position corresponding to one of the second objects that is related to the first object. In some embodiments, the electronic device 2 may be unlocked when any one of the first objects is moved to a position corresponding to one of the second objects that is related to said one of the first objects.

Referring to FIG. 4, an example of the plurality of objects displayed on the touchscreen 21 is shown. In this example, the touchscreen 21 displays three pictures 31-33 of three celebrities as the first objects, and three text boxes 31′-33′ that have names of the celebrities as the second objects. That is, in FIG. 4, the objects in the left column are the first objects and the objects in the right column are the second objects, but the present disclosure is not limited in this respect. For example, the pictures 31, 32, 33 are respectively of Michael Jackson, Michael Jordan and Albert Einstein, and the three text boxes 31′, 32′, 33′ have texts of “MICHAEL JACKSON”, “MICHAEL JORDAN” and “ALBERT EINSTEIN”. When a user of the electronic device 2 intends to unlock the electronic device 2, the user first contacts the touchscreen 21 at a first location corresponding to one of the first objects (for example, the picture 31 of Michael Jackson), maintains the contact with the touchscreen 21 while moving from the first location to a second location corresponding to one of the second objects (for example, the text box 31′ containing the words “MICHAEL JACKSON”) so as to move said one of the first objects (the picture 31) on the touchscreen 21 to the second location (essentially dragging said first object from the first location to the second location). At this time, the electronic device 2 is unlocked. In one embodiment, the electronic device 2 is unlocked once one of the first objects is dragged to the respective one of the second objects. In other embodiments of this disclosure, the electronic device 2 is unlocked only when each of the first objects is dragged to the corresponding one of the second objects that has the logical relationship with the first object (for example, object 31 is dragged to object 31′, object 32 is dragged to object 32′, and object 33 is dragged to object 33′).

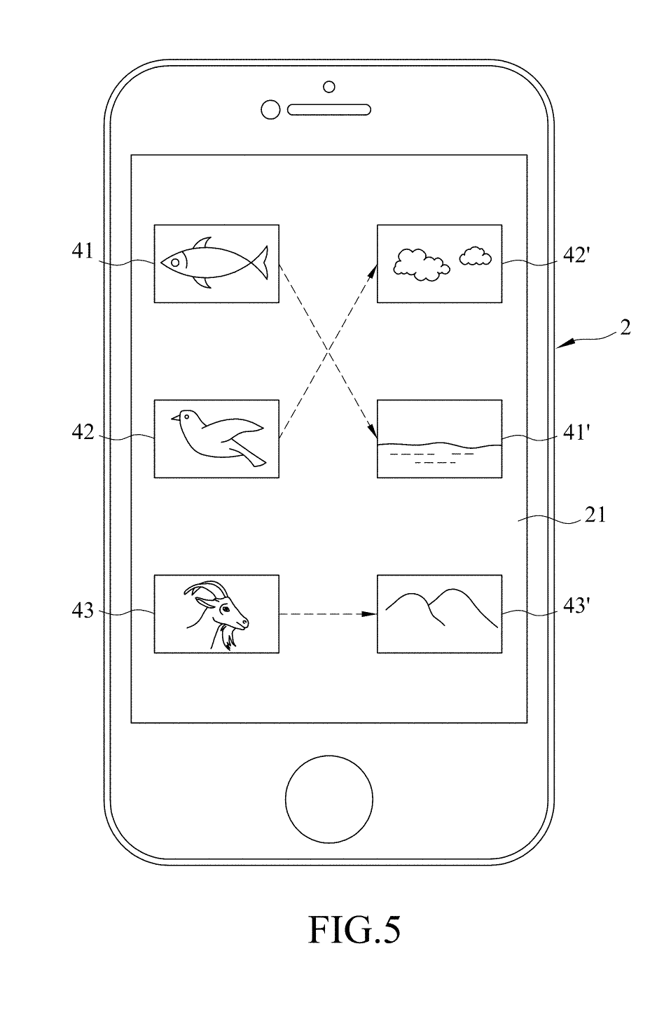

Referring to FIG. 5, another example of the plurality of objects displayed on the touchscreen 21 is shown. In this example, the touchscreen 21 displays three animal images 41-43 respectively of three different animals as the first objects, and three habitat images 41′-43′ each representing a habitat of a respective one the three different animals as the second objects. For example, the animal images 41, 42, 43 respectively represent a fish, a bird and a goat, the habitat images 41′, 42′, 43′ respectively represent the ocean (i.e., the habitat of fish), the sky (i.e., the habitat of bird), and mountains (i.e., the habitat of goat). The user can operate the touchscreen 21 to move each of the animal images 41, 42, 43 on the touchscreen 21 to a position corresponding to the respective one of the habitat images 41′, 42′, 43′ according to the logical relationship between the first objects and the second objects so as to unlock the electronic device 2. The logical relationship between the first objects and the second objects in this example is the association between animal and habitat generally known for the animal, and includes that fish exists in the ocean, bird flies in the sky and goat inhabits in mountains.

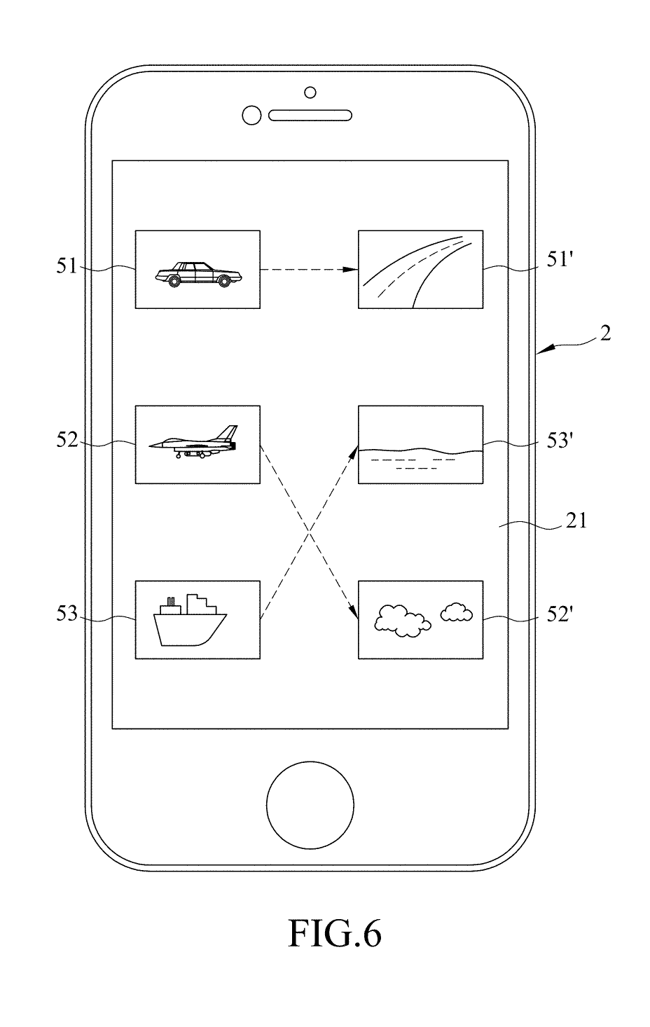

Referring to FIG. 6, still another example of the plurality of objects displayed on the touchscreen 21 of this embodiment is shown. In this example, the touchscreen 21 displays three vehicle images 51-53 respectively of three different types of vehicles as the first objects, and three environment images 51′-53′ respectively representing where the vehicles travel as the second objects. For example, the vehicle images 51, 52, 53 respectively represent a car, an airplane and a ship, and the environment images 51′, 52′, 53′ respectively represent a road, the sky, and the ocean. The user can operate the touchscreen 21 to move each of the pictures 51, 52, 53 on the touchscreen 21 to a position corresponding to the respective one of the pictures 51′, 52′, 53′ according to the logical relationship between the first objects and the second objects, so as to unlock the electronic device 2. The logical relationship between the first objects and the second objects in this example is the association between vehicle and environment the transportation means is commonly used in, and includes that the car travels on the road, the airplane flies in the sky and the ship travels the ocean.

It should be noted that in the examples shown in FIGS. 4 to 6, the three first objects are logically related respectively to the three second objects. In other embodiments of this disclosure, the touchscreen 21 can display more than three first objects and more than three second objects that have the same logical relationship respectively with the first objects. Further, besides the first objects and the second objects, the touchscreen 21 may further display some irrelevant objects that do not have logical relationship with any object displayed on the touchscreen 21 to thereby increase the difficulty for unlocking the electronic device 2 and the present disclosure is not limited in this respect.

In some embodiments, the first objects and the second objects may be displayed randomly at respective positions, as opposed to being aligned in two columns, as in the above examples. Since the positions of the first objects and the second objects displayed on the touchscreen 21 are not fixed, it is not easy for other people to know a specific movement of the contact by the user that is able to unlock the electronic device 2. The logical relationship between the first objects and the second objects illustrated in FIGS. 4 to 6 are some relatively simple examples. In other embodiments, the first objects and the respective second objects having more complicated logical relationship therebetween may be utilized to increase the difficulty in unlocking the electronic device 2. In addition, since thinking is involved in the determination of the logical relationship between the first objects and the second objects and which one of the second objects is logically correlated to a touched one of the first objects when unlocking the electronic device 2, an elder user can be led to think logically more often. In one embodiment, for the same electronic device 2, the objects presented on the touchscreen 21 during one unlocking operation may differ from the object presented on the touchscreen 21 during another unlocking operation.

It should be noted that the first and second objects in the above examples may interchange (e.g., the first objects are habitats and the second objects are animals). Further, data associated with the first and second objects, and the irrelevant objects, if any, and the logical relationships used for unlocking the electronic device 2 are stored in a memory 23 of the electronic device 2 that is electrically connected to the processor 22, as one of ordinary skill in the art would appreciate.

Now referring to FIGS. 7 to 9, another embodiment of the present disclosure will be described. In this embodiment, the electronic device 2 further includes a contact list 82 that is stored in the memory 23, and the memory 23 is installed with a social network application 81 therein. In this embodiment, the plurality of objects displayed on the touchscreen 21 include first objects and second objects having a relationship according to personal data of the user of the electronic device 2. It should be noted that the term “processor” may refer to any device or portion of a device that processes electronic data from registers and/or memory to transform that electronic data into other electronic data. For example, the processor 22 may include, but not limited to, a single core processor, a multi-core processor, a dual-core processor, a microprocessor, a microcontroller, a digital signal processor (DSP), a field-programmable gate array (FPGA), an application specific integrated circuit (ASIC), a radio-frequency integrated circuit (RFIC), etc. The memory 23 is a non-volatile memory, for example, a read-only memory (ROM), random-access memory (RAM), magnetic disk storage media, optical storage media, flash memory, solid state devices (SSD), or other storage devices or media.

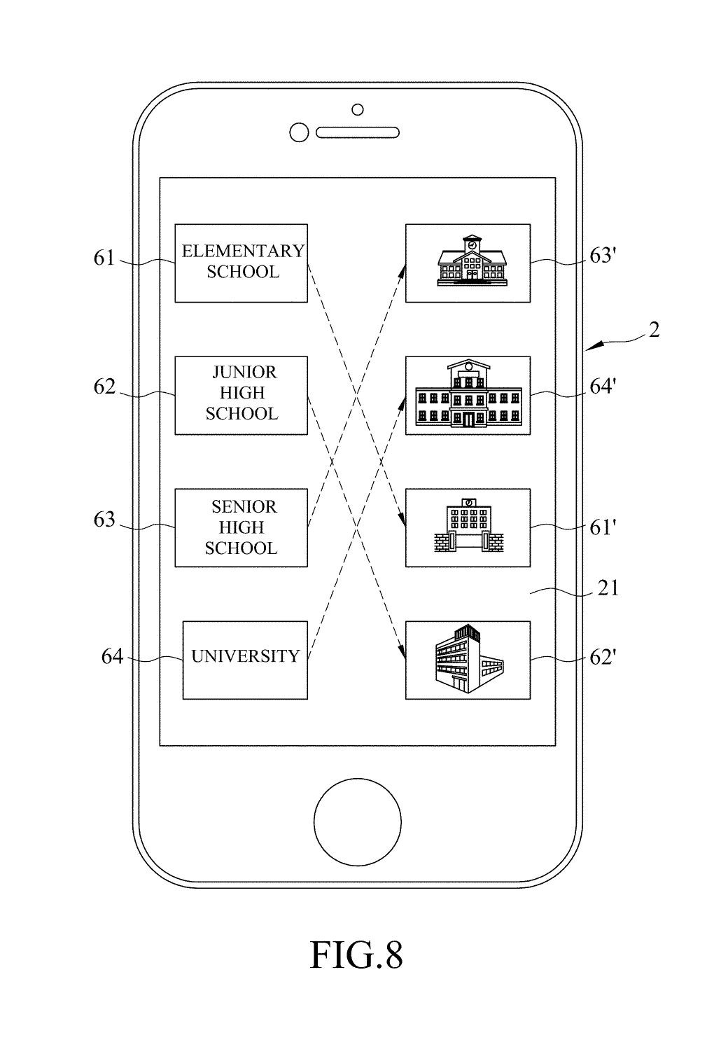

For an example shown in FIG. 8, step S1 of the method of FIG. 3 includes the processor 22 first retrieving educational information of the user through the social network application 81, and the touchscreen 21 displaying four text boxes 61-64 that have respective four terms indicating respectively four educational stages as the first objects, and four pictures 61′-64′ of schools, which the user attended respectively in the educational stages, as the second objects. For example, the text boxes 61, 62, 63, 64 have terms of “ELEMENTARY SCHOOL”, “JUNIOR HIGH SCHOOL”, “SENIOR HIGH SCHOOL”, and “UNIVERSITY”, and the pictures 61′, 62′, 63′, 64′ are a building of the elementary school the user attended, a building of the junior high school the user attended, a building of the senior high school the user attended, and of a building of the university the user attended. The pictures of the buildings may be retrieved from the Internet, for example. The user can operate the touchscreen 21 based on his/her memory of the appearance of the buildings to move each of the text boxes 61, 62, 63, 64 on the touchscreen 21 to a position corresponding to the respective one of the pictures 61′, 62′, 63′, 64′, to thereby unlock the electronic device 2. That is, the user drags the text box 61 having the term “ELEMENTARY SCHOOL” to a position corresponding to the picture 61′ of a building of the elementary school, drags the text box 62 having the term “JUNIOR HIGH SCHOOL” to a position corresponding to the picture 62′ of a building of the junior high school, drags the text box 63 having the term “SENIOR HIGH SCHOOL” to a position corresponding to the picture 63′ of a building of the senior high school, and drags the text box 64 having the term “UNIVERSITY” to a position corresponding to the picture 64′ of a building of the university to unlock the electronic device 2.

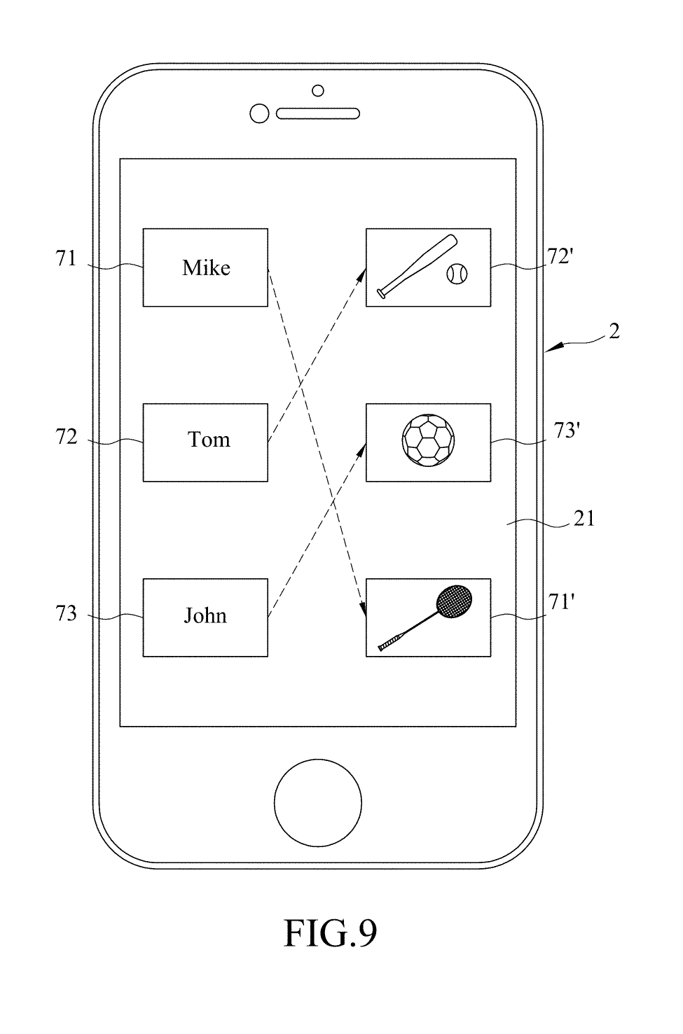

Referring to FIG. 9, another example of this embodiment of the plurality of objects displayed on the touchscreen 21 is shown. In this example, step S1 of the method of FIG. 3 includes the processor 22 first retrieving information of, for example, three persons in the contact list 82 through the social network application 81, and the touchscreen 21 displaying three text boxes 71, 72, 73 that have names of the three persons in the contact list 82 as the first objects and three visual images 71′, 72′, 73′ each representing a piece of information, e.g., hobby, of a respective one of the three persons as the second objects. The user can operate the touchscreen 21 based on his/her knowledge of the three persons to move each of the text boxes 71, 72, 73 to a position corresponding to the respective one of the visual images 71′, 72′, 73′, in order to unlock the electronic device 2. That is to say, the user can unlock the electronic device 2 by dragging the text box 71 having the name “Mike” to a position corresponding to the picture 71′ of badminton, dragging the text box 72 having the name “Tom” to a position corresponding to the picture 72′ of baseball, and dragging the text box 73 having the name “John” to a position corresponding to the picture 73′ of soccer.

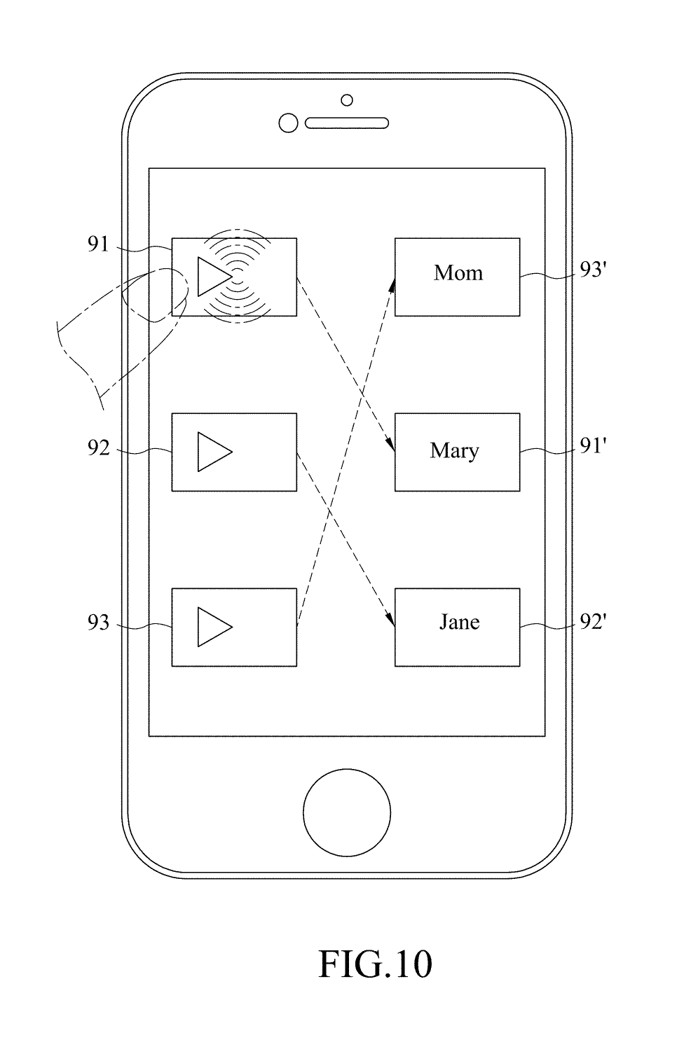

Now referring to FIGS. 7 and 10, another embodiment of the present disclosure will be described. In this embodiment, the electronic device 2 further includes a voice database 83 electrically connected to the processor 22 and storing an audio file of a voice record of one or more persons in the contact list 82. For example, the voice database 83 is a non-transitory memory mechanism, such as read-only memory (ROM), random-access memory (RAM), magnetic disk storage media, optical storage media, flash memory, solid state devices (SSD), or other storage devices or media.

In this embodiment, the touchscreen 21 displays three visual objects 91, 92, 93 that are three play button icons and that are respectively associated with the audio files of three persons in the contact list 82 as the first objects, and three text boxes 91′, 92′, 93′ that have names “Mary”, “Jane” and “Mom” of the three persons in the contact list 82 as the second objects. In this embodiment, for each of the visual objects 91-93, after the electronic device 2 detects contact with the touchscreen 21 at a first location corresponding to the visual object 91, 92, 93, the processor 22 executes, a corresponding one of the audio files that is associated with the visual object 91, 92, 93 to play the voice record, and the user has to recognize the voice record belonging to which one of the three persons. For example, the visual objects 91-93 are associated respectively with the voice records respectively of Mary, Jane and Mom. By this way, the user can unlock the electronic device 2 by dragging each of the visual objects 91, 92, 93 to the position corresponding to the respective one of the text boxes 91′, 92′, 93′ based on his/her knowledge of the voice of each of the three persons.

It should be noted that in the abovementioned embodiments, the first objects and the second objects have either logical relationship, or relationship on a personal level of the user of the electronic device 2; the former aids in training the brain as one unlocks the electronic device, and the latter adds a level of security to the access to the electronic device 2, in a way similar to entering a password pre-set by the user. In other embodiments, in order to enhance security to the access to the electronic device 2, the user may operate the electronic device 2 to implement different embodiments at different times, or to randomly implement one of the embodiments. Furthermore, the logical relationship may become more and more complicated over time, and thus security for unlocking the electronic device 2 can be further improved.

To sum up, the method for unlocking the electronic device 2 makes the touchscreen 21 display a plurality of objects including at least one first object and at least one second object that is logically related to the first object. In some embodiments, the second object has a relationship with the first object according to personal information or knowledge of the user (e.g., FIGS. 8-10), such that the method for unlocking the electronic device 2 is exclusive to the user of the electronic device 2. Further, the user can be led to practice logical thinking when unlocking the electronic device 2. Additionally, since the positions of the first and second objects displayed on the touchscreen 21 may be random, it is relatively difficult for other people to know how to unlock the electronic device 2.

In the description above, for the purposes of explanation, numerous specific details have been set forth in order to provide a thorough understanding of the embodiment. It will be apparent, however, to one skilled in the art, that one or more other embodiments maybe practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for unlocking an electronic device including a touchscreen, the method comprising steps of:
displaying, on the touchscreen, a plurality of objects including at least one first object and at least one second object that is related to the first object;
detecting a contact with the touchscreen at a first location corresponding to the first object;
continuously moving the first object on the touchscreen in accordance with movement of the contact while the contact with the touchscreen is continuously maintained; and
unlocking the electronic device when the first object is moved to a second location that corresponds to the second object.

2. The method as claimed in claim 1, wherein the step of displaying a plurality of objects includes displaying the first object and the second object to have a relationship according to personal data of a user of the electronic device.

3. The method as claimed in claim 2, the electronic device further including a contact list and a voice database that stores an audio file of a voice record of a person in the contact list, wherein the step of displaying a plurality of objects includes:
displaying a visual object that is associated with the audio file as one of the first and second objects; and
displaying a text box that has a name of the person in the contact list as the other one of the first and second objects,
wherein the method further comprises a step of executing the audio file to play the voice record upon detecting contact with the touchscreen at the first location.

4. The method as claimed in claim 2, the electronic device further including a contact list, wherein the step of displaying a plurality of objects includes:
displaying a text box that has a name of a person in the contact list as one of the first and second objects; and
displaying a visual image representing a piece of information of the person as the other one of the first and second objects.

5. The method as claimed in claim 4, wherein the step of displaying a visual image representing a piece of information of the person includes retrieving information of the person through a social network application installed in the electronic device.

6. The method as claimed in claim 2, wherein the step of displaying a plurality of objects includes:
displaying a text box that has a term indicating an educational stage as one of the first and second objects; and
displaying a picture of a school, which the user of the electronic device attended in the educational stage, as the other one of the first and second objects.

7. The method as claimed in claim 6, wherein the step of displaying a plurality of objects further includes retrieving educational information of the user through a social network application installed in the electronic device.

8. The method as claimed in claim 1, wherein the step of displaying a plurality of objects includes displaying the first object and the second object to have a logical relationship.

9. The method as claimed in claim 8, wherein the step of displaying a plurality of objects includes displaying an image of a vehicle as one of the first and second objects, and displaying an image representing where the vehicle is used as the other one of the first and second objects.

10. The method as claimed in claim 8, wherein the step of displaying a plurality of objects includes displaying an image of an animal as one of the first and second objects, and displaying an image representing a habitat of the animal as the other one of the first and second objects.

11. The method as claimed claim 8, wherein the step of displaying a plurality of objects includes displaying a picture of a celebrity as one of the first and second objects, and displaying a text box that has a name of the celebrity as the other one of the first and second objects.
